(19) United States
(12) Patent Application Publication
(10) Pub. No.: US 2011/0098372 A1
(43) Pub. Date: Apr. 28, 2011

(54) FOAMABLE POLYAMIDES

(75) Inventors: Francesca Aulenta, Mannheim (DE); Cecile Gibon, Mannheim (DE); Arnold Schneller, Seeheim-Jugenheim (DE); Martin Weber, Maikammer (DE)

(73) Assignee: BASF SE, Ludwigshafen (DE)

(21) Appl. No.: 13/001,636

(22) PCT Filed: Jun. 9, 2009
(86) PCT No.: PCT/EP2009/057066

§ 371 Date: Dec. 28, 2010

(30) Foreign Application Priority Data
Jul. 2, 2008 (EP) 08159517.5

(51) Int. Cl. C08J 9/35; C08L 33/24

(52) U.S. Cl. 521/139; 521/134

(57) ABSTRACT

Thermoplastic molding compositions comprising

A) from 10 to 99.9% by weight of at least one thermoplastic polyamide
B) from 0.1 to 50% by weight of a copolymer obtainable via
(i) preparation of at least one reaction mixture (a) via free-radical copolymerization of one or more monoethylenically unsaturated monomeric compound(s) (monomer(s) B1) with one or more compound(s) selected from the group of itaconic acid, mesaconic acid, fumaric acid, maleic acid, aconitic acid, glutaconic acid, and salts, esters, and anhydrides thereof (monomer(s) B2), and
(ii) if appropriate, reaction of at least one of the copolymers obtained in step (i) with one or more crosslinking agent(s) (b), and
   C) from 0 to 60% by weight of further additives,
   where the total of the percentages by weight of components A) to C) is 100%.

The invention relates to thermoplastic molding compositions comprising

A) from 10 to 99.9% by weight of at least one thermoplastic polyamide
B) from 0.1 to 50% by weight of a copolymer obtainable via
(i) preparation of at least one reaction mixture (a) via free-radical copolymerization of one or more monoethylenically unsaturated monomeric compound(s) (monomer(s) B1) with one or more compound(s) selected from the group of itaconic acid, mesaconic acid, fumaric acid, maleic acid, aconitic acid, glutaconic acid, and salts, esters, and anhydrides thereof (monomer(s) B2), and
(ii) if appropriate, reaction of at least one of the copolymers obtained in step (i) with one or more crosslinking agent(s) (b), and
   C) from 0 to 60% by weight of further additives,
   where the total of the percentages by weight of components A) to C) is 100%.

The invention further relates to the moldings of any type obtainable from the molding compositions, and to processes for the production of polymer foams, and also to the resultant foams.

Polyamide foams are known per se and can be produced by using chemical or physical blowing agents.

Chemical blowing agents are mostly disadvantageous, since the foam is mostly produced at above 200° C., whereupon the conventional blowing agents decompose very rapidly.

GB-A 1 226 340 discloses foams of this type which comprise a chemical blowing agent based on COOH and, respectively, ester groups adjacent to ketone, ester, or COOH groups. The decomposition provides CO₂ and thus leads to foaming. However, this takes place rapidly, and controllability of foaming is therefore poor.

U.S. Pat. No. 4,070,426 discloses foams which liberate water as blowing agent via a condensation reaction. However, a precondition of this method is that the polyamides are mainly NH₂ terminated.

GB 11 32 105 discloses further polyamide foams which are obtainable via decomposition of another polymer incorporated in the mixture (to give monomers). Since there is a relatively close relationship between the decomposition temperature of this polymer and the melting point of the polyamide, the tolerance in parameters for foam production is very narrow. The systems are moreover not freely exchangeable.

Another disadvantage of the methods known from the prior art is that the foaming process mostly occurs before the end of the extrusion process, i.e. when these processes are used with selected starting materials it is not possible to achieve controlled foam production.

It was therefore an object of the present invention to provide polyamide molding compositions which can give controlled and easy foaming. There should be maximum uniformity of melt viscosity and of the resultant pore volumes.

Accordingly, the molding compositions defined in the introduction have been found. The subclaims give preferred embodiments. A process has moreover been found for the production of polymer foams, as also have the moldings of any type obtainable from the molding compositions or from the polymer foams.

The polyamides then crosslink to some extent with the copolymer (e.g. imide function) during the mixing process (e.g. via extrusion). The pellets can advantageously be stored for prolonged periods.

A microcellular polymer foam is produced in a controlled manner over a certain period at an elevated temperature, mainly via CO₂/H₂O elimination. The blowing agent is in homogeneously distributed form, bonded within the PA matrix, and is non-combustible.

Note relating to the quantitative data given below: the amounts of components A) to C) in the thermoplastic molding composition are selected within the ranges mentioned in such a way that the entirety of components A) and B), and also, if appropriate, C) is 100% by weight; component C) is optional.

The molding compositions of the invention comprise, as component A), from 10 to 99.9% by weight, preferably from 20 to 99% by weight, and in particular from 30 to 94% by weight, of at least one thermoplastic polyamide A).

The viscosity number of the polyamides of the molding compositions of the invention is generally from 30 to 350 ml/g, preferably from 40 to 200 ml/g, determined in a 0.5% strength by weight solution in 96% strength by weight sulfuric acid at 25° C. to ISO 307.

Semicrystalline or amorphous resins whose molecular weight (weight-average) is at least 5000 are preferred, examples being those described in the U.S. Pat. Nos. 2,071,250, 2,071,251, 2,130,523, 2,130,948, 2,241,322, 2,312,966, 2,512,606, and 3,393,210.

It is preferable to use polyamides which derive from lactams having from 7 to 13 ring members, for example polycaprolactam, polycaprylolactam, and polylaurolactam, and also polyamides obtained via reaction of dicarboxylic acids with diamines.

Dicarboxylic acids that can be used are alkanedicarboxylic acids having from 6 to 12, in particular from 6 to 10 carbon atoms, and aromatic dicarboxylic acids. Just a few acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di-(4-aminocyclohexyl)methane, 2,2-di(4-aminophenyl)propane, 2,2-di(4-aminocyclohexyl)propane, or 1,5-diamino-2-methylpentane.

Preferred polyamides are polyhexamethyleneadipamide, polyhexamethylene-sebacamide, and polycaprolactam, and also nylon-6/6,6 copolyamides, in particular having from 5 to 95% by weight content of caprolactam units.

Other suitable polyamides are obtainable from ω-aminoalkylnitriles, such as aminocapronitrile (PA 6) and adipodinitrile with hexamethylenediamine (PA 66), by what is known as direct polymerization in the presence of water, as described by way of example in DE-A 10313681, EP-A 1198491, and EP 922065.

Mention may also be made of polyamides obtainable by way of example via condensation of 1,4-diaminobutane with adipic acid at an elevated temperature (nylon-4,6). Preparation processes for polyamides of said structure are described by way of example in EP-A 38 094, EP-A 38 582, and EP-A 39 524.

Other suitable polyamides are those obtainable via copolymerization of two or more of the abovementioned monomers, or a mixture of a plurality of polyamides, in any desired mixing ratio.

Semiaromatic copolyamides, such as PA 6/6T and PA 66/6T, have moreover proven particularly advantageous, in particular those whose triamine content is less than 0.5% by weight, preferably less than 0.3% by weight (see EP-A 299 444).

The processes described in EP-A 129 195 and 129 196 can be used to prepare the preferred semiaromatic copolyamides having low triamine content.

The preferred semiaromatic copolyamides A) comprise, as component a₁), from 40 to 90% by weight of units which derive from terephthalic acid and from hexamethylenediamine. A small proportion of the terephthalic acid, preferably not more than 10% by weight of the entire aromatic dicarboxylic acids used, can be replaced by isophthalic acid or other aromatic dicarboxylic acids, preferably those in which the carboxy groups are in para position.

The semiaromatic copolyamides comprise, alongside the units which derive from terephthalic acid and from hexamethylenediamine, units which derive from ε-caprolactam (a₂), and/or units which derive from adipic acid and hexamethylenediamine (a₃).

The proportion of units which derive from ε-caprolactam is at most 50% by weight, preferably from 20 to 50% by weight, in particular from 25 to 40% by weight, while the proportion of units which derive from adipic acid and hexamethylenediamine is up to 60% by weight, preferably from 30 to 60% by weight, and in particular from 35 to 55% by weight.

The copolyamides can also comprise not only units of ε-caprolactam but also units of adipic acid and hexamethylenediamine; in this case, care has to be taken that the proportion of units free from aromatic groups is at least 10% by weight, preferably at least 20% by weight. The ratio of the units which derive from ε-caprolactam and from adipic acid and hexamethylenediamine here is not subject to any particular restriction.

Polyamides which have proven particularly advantageous for many applications are those having from 50 to 80% by weight, in particular from 60 to 75% by weight, of units which derive from terephthalic acid and from hexamethylenediamine (units a₁)) and from 20 to 50% by weight, preferably from 25 to 40% by weight, of units which derive from ε-caprolactam (units a₂)).

The semiaromatic copolyamides of the invention can also comprise, alongside the units a₁) to a₃) described above, an amount which is preferably not more than 15% by weight, in particular not more than 10% by weight, of the other polyamide units (a₄) known from other polyamides. These units can derive from dicarboxylic acids having from 4 to 16 carbon atoms and from aliphatic or cycloaliphatic diamines having from 4 to 16 carbon atoms, and also from aminocarboxylic acids and, respectively, corresponding lactams having from 7 to 12 carbon atoms. Monomers of these types that may be mentioned here merely as examples are suberic acid, azelaic acid, sebacic acid, or isophthalic acid as representatives of the dicarboxylic acids, 1,4-butanediamine, 1,5-pentanediamine, piperazine, 4,4′-diaminodicyclohexylmethane, and 2,2-(4,4′-diaminodicyclohexyl)propane or 3,3′-dimethyl-4,4″-diaminodicyclohexylmethane as representatives of the diamines, and caprylolactam, enantholactam, omega-aminoundecanoic acid, and laurolactam as representatives of lactams and, respectively, aminocarboxylic acids.

The melting points of the semiaromatic copolyamides A) are in the range from 260 to more than 300° C., and this high melting point is also associated with a high glass transition temperature which is generally more than 75° C., in particular more than 85° C.

If binary copolyamides based on terephthalic acid, hexamethylenediamine, and ε-caprolactam have about 70% by weight content of units derived from terephthalic-acid and from hexamethylenediamine, their melting points are in the region of 300° C. and their glass transition temperature is above 110° C.

Binary copolyamides based on terephthalic acid, adipic acid, and hexamethylenediamine (HMD) achieve melting points of 300° C. and more even at relatively low contents of units derived from terephthalic acid and from hexamethylenediamine, of about 55% by weight, but here the glass transition temperature is not quite as high as for binary copolyamides which comprise ε-caprolactam instead of adipic acid or adipic acid/HMD.

The following list, which is not comprehensive, comprises the polyamides A) mentioned and other polyamides A) for the purposes of the invention, and the monomers comprised.

AB polymers:

### PA 4 Pyrrolidone

### PA 6 ε-Caprolactam

### PA 7 Ethanolactam

### PA 8 Caprylolactam

PA 9 9-Aminopelargonic acid

PA 11 11-Aminoundecanoic acid

### PA 12 Laurolactam

AA/BB polymers
PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA 9T Nonyldiamine/terephthalic acid
PA MXD6 m-Xylylenediamine, adipic acid
PA 6I Hexamethylenediamine, isophthalic acid
PA 6-3-T Trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 6I/6T (see PA 61 and PA 6T)

PA PACM 12 Diaminodicyclohexylmethane, laurolactam
PA 6I/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

However, it is also possible to use a mixture of the above polyamides.

Other monomers that can be used are cyclic diamines, such as those of the general formula (I)

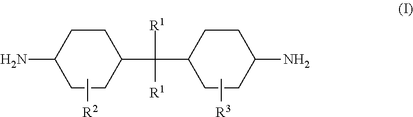

in which R₁ is hydrogen or a C₁-C₄-alkyl group, R₂ is a C₁-C₄-alkyl group or hydrogen, and R₃ is a C₁-C₄-alkyl group or hydrogen.

Particularly preferred diamines (I) are bis(4-aminocyclohexyl)methane, bis(4-amino-3-methylcyclohexyl)methane, bis(4-aminocyclohexyl)-2,2-propane or bis(4-amino-3-methylcyclohexyl)-2,2-propane, 1,3- or 1,4-Cyclohexanediamine or isophoronediamine are mentioned as other diamines (I).

Particular preference is given here to mixtures composed of amorphous polyamides with other amorphous PAs or with semicrystalline polyamides, and the semicrystalline fraction here can be from 0 to 50% by weight, preferably from 1 to 35% by weight, based on 100% by weight of A).

Preferred mixtures are PA 61 with nylon-5/10, or are nylon-6/6,6 copolymers, which can comprise PA 61 fractions. These are commercially available as Ultramid® 1C (BASF SE).

The molding compositions of the invention can comprise, as component B), from 0.1 to 50% by weight, preferably from 1 to 45% by weight, and in particular form 5 to 40% by weight, of a copolymer obtainable via

(i) preparation of at least one reaction mixture
(a) via free-radical copolymerization of one or more monoethylenically unsaturated monomeric compound(s) or anhydride(s) thereof (monomer(s) B1) with one or more compound(s) selected from the group of itaconic acid, mesaconic acid, fumaric acid, maleic acid, aconitic acid, glutaconic acid, and salts, esters, and anhydrides thereof (monomer(s) B2) obtained copolymers and
   (ii) if appropriate, reaction of at least one of the copolymers obtained in step (i),
   with (b) one or more crosslinking agent(s).

Monomers B1 that can be used are in principle any of the ethylenically unsaturated monomers capable of free-radical copolymerization with the monomers B2. e.g. ethylenically unsaturated, in particular α,β-monoethylenically unsaturated, C₃-C₆, preferably C₃ or C₄, mono- or dicarboxylic acids, and their water-soluble salts, in particular their alkali metal salts or ammonium salts, e.g. acrylic acid, methacrylic acid, ethylacrylic acid, allylacetic acid, crotonic acid, vinylacetic acid, fumaric acid, maleic acid, maleic anhydride, methylmaleic acid and the ammonium, sodium or potassium salts of the abovementioned acids.

Alkyl acrylates having alkyl radicals of from 1C to 20 carbon atoms, preferably 2 to 10 carbon atoms may also be comprised. Preference is given here to n-butyl, isopropyl, tert-butyl, ethyl, n-propyl, and isobutyl acrylate.

Examples of other monomers B1 that can be used alongside these are vinylaromatic monomers, such as styrene, or substituted styrenes of the general formula

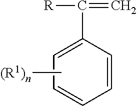

where R are alkyl radicals having from 1 to 8 carbon atoms, hydrogen atoms, or halogen atoms, and R¹ are alkyl radicals having from 1 to 8 carbon atoms, or halogen atoms, and n has the value 0, 1, 2, or 3, preference being given to α-methylstyrene, o-chlorostyrene, or vinyltoluenes, vinyl halides, such as vinyl chloride or vinylidene chloride, esters composed of vinyl alcohol and of monocarboxylic acids having from 1 to 18 carbon atoms, e.g. vinyl acetate, vinyl propionate, vinyl n-butyrate, vinyl laurate and vinyl stearate, esters composed of α,β-monoethylenically unsaturated mono- and dicarboxylic acids, preferably having from 3 to 6 carbon atoms, e.g. in particular acrylic acid, methacrylic acid, maleic acid, fumaric acid, and itaconic acid, with alkanols generally having from 1 to 12, preferably from 1 to 8, and in particular from 1 to 4, carbon atoms, e.g. particularly methyl, ethyl, n-butyl, isobutyl, pentyl, hexyl, heptyl, octyl, nonyl, decyl and 2-ethylhexyl acrylates and the corresponding methacrylates, dimethyl or di-n-butyl fumarates and the corresponding maleates, nitriles of α,β-monoethylenically unsaturated carboxylic acids, e.g. acrylonitrile, methacrylonitrile, fumaronitrile, maleonitrile, and C4-8-conjugated dienes, such as 1,3-butadiene (butadiene) and isoprene. Other monomers B1 which can be used are those ethylenically unsaturated monomers which have at least one sulfonic acid group and/or its corresponding anion and/or have at least one amino, amido, ureido, or N-heterocyclic group and/or its nitrogen-protonated or -alkylated ammonium derivatives. Examples that may be mentioned are acrylamide and methacrylamide, and also vinylsulfonic acid, 2-acrylamido-2-methylpropanesulfonic acid, styrenesulfonic acid and water-soluble salts thereof, and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate, glycidyl acrylate.

Monoethylenically unsaturated monomeric compounds used or, if appropriate, their anhydrides or esters are preferably styrene, α-methylstyrene, o-chlorostyrene, vinyl chloride, vinylidene chloride, vinyl acetate, vinyl propionate, vinyl n-butyrate, vinyl laurate, vinyl stearate, itaconic acid, acrylonitrile, methacrylonitrile, fumaronitrile, maleonitrile, 1,3-butadiene (butadiene), isoprene, acrylamide and methacrylamide, vinylsulfonic acid, acrylic acid, methacrylic acid, maleic acid, ethacrylic acid. α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearylic acid, citraconic acid, aconitic acid, fumaric acid, tricarboxyethylene anhydride and maleic anhydride, and particular preference is given here to acrylic acid and methacrylic acid, styrene, and methyl(meth)acrylate.

Monomers B2 that can be used are itaconic acid, mesaconic acid, fumaric acid, maleic acid, aconitic acid, and glutaconic acid, and their salts, anhydrides and/or alkyl esters. Alkyl esters here are intended as meaning not only the corresponding monoalkyl esters, but also the di- or trialkyl esters, in particular the corresponding C₁-C₂₀-alkyl esters, preferably the mono- or dimethyl or -ethyl esters. The invention is, of course, also intended to comprise the corresponding salts of the abovementioned acids, e.g. the alkali metal salts, alkaline earth metal salts, or the ammonium salts, in particular the corresponding sodium, potassium or ammonium salts. According to one preferred embodiment of the invention, itaconic acid or itaconic anhydride is used, but particular preference is given here to itaconic acid.

The reaction mixture (a) comprises from 0.1 to 70% by weight, preferably from 1 to 50% by weight and with particular preference from 1 to 25% by weight, of at least one monomer B2 in copolymerized form.

According to one preferred embodiment, the ratio of the monoethylenically unsaturated compound (monomers B1) to the one or more compounds selected from the group of itaconic acid, mesaconic acid, glutaconic acid, fumaric acid, maleic acid, and aconitic acid and their salts, esters and anhydrides (monomers B2) is in the range from 1 to 50% by weight of at least one monomer B2, and from 50 to 99% by weight of at least one monomer B1 and with particular advantage from 1 to 25% by weight of at least one monomer B2 and from 75 to 99% by weight of at least one monomer B1. The percentage by weight data here are always based on the entire copolymer B).

The Fikentscher K value of the copolymer comprised in the reaction mixture (a), see page 10 (1% strength in deionized water) is usually from 10 to 80, preferably from 2 to 50, particularly preferably from 20 to 38. The weight-average molar mass of the copolymer comprised in the reaction mixture (a) is from 3000 to 1 000 000 g/mol, preferably from 3000 to 600 000 g/mol, particularly preferably from 3000 to 100 000 g/mol, with particular preference from 3000 to 35 000 g/mol.

According to the invention, preferred crosslinking agents of feature (b) are compounds which have at least two functional groups which can react with the free functional groups of the copolymers comprised in the reaction mixture (a), in a condensation reaction or in an addition reaction.

Examples that may be mentioned as crosslinking agents (b) are polyols, e.g. ethylene glycol, polyethylene glycol such as diethylene glycol, triethylene glycol and tetraethylene glycol, propylene glycol, polypropylene glycol, such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene-oxypropylene block copolymers, sorbitan fatty acid esters, polyoxyethylenesorbitan fatty acid esters, pentaerythritol, polyvinyl alcohol, and sorbitol, aminoalcohols, e.g. ethanolamine, diethanolamine, triethanolamine or propanolamine, polyamine compounds, e.g. ethylenediamine, diethylenetetramine, triethylenetetramine, tetraethylenepentamine or pentaethylenehexamine, N,N,N,N-tetrakis(2-hydroxyethyl)ethylenediamine (THEED), N,N,N,N-tetrakis(2-hydroxyethyl)adipamide (THEAA), triisopropanolamine (TRIPA), polyglycidic ether compounds, such as ethylene glycol diglycidyl ether, polyethylene glycol diglycidyl ether, glycerol polyglycidyl ether, pentaerythritol polyglycidyl ether, propylene glycol diglycidyl ether, polypropylene glycol diglycidyl ether, neopentyl glycol diglycidyl ether, hexanediol glycidyl ether, trimethylolpropanol glycidyl ether, sorbitol polyglycidyl ether, phthalic acid diglycidyl ether, adipic acid diglycidyl ether, glycidol, polyisocyanates, preferably diisocyanates, such as toluene 2,4-diisocyanate and hexamethylene diisocyanate, polyaziridine compounds, such as 2,2-bishydroxymethylbutanol tris[3-(1-aziridinyl)propionate], 1,6-hexamethylene-diethyleneurea and diphenylmethanebis-4,4′-N,N′-diethyleneurea, halogen peroxides such as epichlorohydrin and epibromohydrin and α-methylepichlorohydrin, alkylene carbonates such as 1,3-dioxolan-2-one (ethylene carbonate), 4-methyl-1,3-dioxolan-2-one(propylene carbonate), polyquaternary amines such as condensates of dimethylamines and epichlorohydrin, di-, tri- and polyamines and polyol compounds having at least two hydroxy groups.

The polyol compound, hereinafter termed polyol, can in principle be a compound whose molar mass is ≦1000 g/mol or a polymeric compound whose molar mass is >1000 g/mol. Examples that may be mentioned of compounds having at least 2 hydroxy groups are polyvinyl alcohol, partially-hydrolyzed polyvinyl acetate, homo- or copolymers of hydroxyalkyl acrylates or of hydroxyalkyl methacrylates, e.g. hydroxyethyl acrylate and the corresponding methacrylate or hydroxypropyl acrylate and the corresponding methacrylate. Examples of other polymeric polyols are found inter alia in WO 97/45461, page 3, line 3 to page 14, line 33.

Any of the organic compounds which have at least 2 hydroxy groups and whose molar mass is ≦1000 g/mol can be used as polyol whose molar mass is ≦1000 g/mol. Examples that may be mentioned are ethylene glycol, propylene 1,2-glycol, glycerol, 1,2- or 1,4-butanediol, pentaerythritol, trimethylolpropane, sorbitol, sucrose, glucose, 1,2-, 1,3- or 1,4-dihydroxybenzene, 1,2,3-trihydroxybenzene, 1,2-, 1,3- or 1,4-dihydroxycyclohexane, and preferably alkanolamines, e.g. compounds of the general formula I

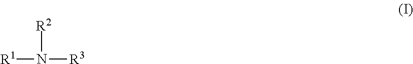

in which R² is a hydrogen atom, a C₁-C₁₀-alkyl group, or a C₂-C₁₀-hydroxyalkyl group, and R² and R³ are a C₂-C₁₀-hydroxyalkyl group.

It is particularly preferable that R² and R³, independently of one another, are a C₂-C₅-hydroxyalkyl group and R¹ is a hydrogen atom, a C₁-C₅-alkyl group, or a C₂-C₅-hydroxyalkyl group.

Particular compounds of the formula I that may be mentioned are diethanolamine, triethanolamine, diisopropanolamine, triisopropanolamine, methyldiethanolamine, butyldiethanolamine and/or methyldiisopropanolamine.

Examples of other polyols whose molar mass is ≦1000 g/mol are likewise found in WO 97/45461, page 3, line 3 to page 14, line 33.

The polyol is preferably selected from the group comprising diethanolamine, triethanolamine, diisopropanolamine, triisopropanolamine, methyldiethanolamine, butyldiethanolamine and/or methyldiisopropanolamine, particular preference being given here to triethanolamine.

Particularly preferred crosslinking agents are triethanolamine, N,N,N,N-tetrakis(2-hydroxyethyl)ethylenediamine, and triisopropanolamine.

The quantitative proportion used of the reaction mixture (a) and the crosslinking agent (b)—if this is comprised—with respect to one another is generally such that the ratio by weight of reaction mixture to crosslinking agent is from 1:10 to 100:1, advantageously from 1:5 to 50:1, and with particular advantage from 1:1 to 20:1.

It is preferable that the amount of the crosslinking agent(s) (b) used is, if appropriate, in the range from 5 to 65% by weight, preferably in the range from 20 to 60% by weight, particularly preferably in the range from 20 to 30% by weight, based in each case on the entire copolymer B).

However, it is also possible to use still further components in the reaction of components (a) and (b). By way of example, it is advantageous to carry out the reaction of components (a) and (b) in the presence of a nucleating agent. A suitable choice of the nucleating agent can vary the structure of the foams, and pore sizes, and pore distribution, as a function of the intended use of the respective foam. The nucleating agent used preferably comprises talc (magnesium silicate), magnesium carbonate, calcium carbonate, huntite, hydromagnesite, and KMgAI silicates, or a mixture of these. It is particularly preferable that the nucleating agent is talc.

The amount used of the further components, such as the nucleating agents, in the reaction mixture comprising (a) and (b) is in the range from 0.1 to 5% by weight, preferably in the range from 0.5 to 2% by weight, particularly preferably in the range from 1 to 1.5% by weight, based on the total weight of the reactants.

The preparation of the foamable copolymers B) preferably comprises the following steps:
(i) preparation of at least one reaction mixture (a) via free-radical copolymerization of one or more monoethylenically unsaturated monomeric compound(s) (monomer(s) B1) with one or more compound(s) selected from the group of itaconic acid, mesaconic acid, glutaconic acid, fumaric acid, maleic acid, aconitic acid, and salts, esters, and anhydrides thereof (monomer(s) B2), and
(ii) if appropriate, reaction of at least one of the copolymers obtained in step (i) with one or more crosslinking agent(s).

The preparation of the reaction mixture in step (i) can take place by various free-radical polymerization processes known to the person skilled in the art. Preference is given to homogeneous-phase free-radical polymerization, in particular in aqueous solution in the form of what is known as gel polymerization, or polymerization in an organic solvent. Other possibilities are precipitation polymerization from organic solvents, for example from alcohols, or suspension, emulsion or microemulsion polymerization. Other adjuvants, such as chain regulators, such as mercaptoethanol, can be used in the polymerization reaction as well as the polymerization initiators.

The free-radical polymerization in step (i) usually takes place in the presence of compounds which are known as initiators and which form free radicals.

The amounts used of these compounds which form free radicals are usually up to 30% by weight, preferably from 0.05 to 15% by weight, in particular from 0.2 to 8% by weight, based on the starting materials to be polymerized. In the case of initiators composed of a plurality of constituents (initiator systems e.g. redox initiator systems) the weight data above are based on the entirety of the components.

Examples of suitable initiators are organic peroxides and hydroperoxides, and also peroxide sulfates, percarbonates, peroxide esters, hydrogen peroxide, and azo compounds. Examples of these initiators are hydrogen peroxide, dicyclohexyl peroxide dicarbonate, diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, methyl ethyl ketone peroxide, di-tert-butyl hydroperoxide, acetylacetone peroxide, butyl peracetate, tert-butyl permaleate, tert-butyl isobutyrate, tert-butyl perpivalate, tert-butyl peroctoate, tert-butyl perneodecanoate, tert-butyl perbenzoate, tert-butyl hydroperoxide, cumene hydroperoxide, tert-butyl perneodecanoate, tert-amyl perpivalate, tert-butyl perpivalate, tert-butoxy-2-ethylhexanoate and diisopropyl peroxydicarbamate; and also lithium peroxodisulfate, sodium peroxodisulfate, potassium peroxodisulfate and ammonium peroxodisulfate, the azo initiators 2,2′-azobisisobutyronitrile, 2,2′-azobis(2-methylbutyronitrile), 2,2′-azobis[2-methyl-N-(2-hydroxyethyl)propionamide, 1,1′-azobis(1-cyclohexane-carbonitrile), 2,2′-azobis(2,4-dimethylvaleronitrile), 2,2′-azobis(N,N′-dimethyleneisobutyroamidine) dihydrochloride, and 2,2′-azobis(2-amidinopropane) dihydrochloride, and the redox initiator systems explained hereinafter.

Redox initiator systems comprise at least one peroxide-containing compound in combination with a redox coinitiator, for example a sulfur compound having reducing action, e.g. bisulfites, sulfites, thiosulfates, dithionites and tetrathionates of alkali metals or of ammonium compounds. Combinations of peroxodisulfates with alkali metal hydrogen sulfites or with ammonium hydrogen sulfites can therefore be used, examples being ammonium peroxodisulfate and ammonium disulfite. The amount of the peroxide-containing compounds with respect to the redox coinitiator is generally from 30:1 to 0.05:1.

The initiators can be used alone or in a mixture with one another, examples being mixtures composed of hydrogen peroxide and sodium peroxodisulfate.

The initiators can be either water-soluble or non-water-soluble, or only sparingly water-soluble. As initiators for the free-radical polymerization in an aqueous medium, it is preferable to use water-soluble initiators, i.e. initiators which are soluble in the aqueous polymerization medium at the concentration usually used for the polymerization reaction. Among these are peroxodisulfates, azo initiators having ionic groups, organic hydroperoxides having up to 6 carbon atoms, acetone hydroperoxide, methyl ethyl ketone hydroperoxide and hydrogen peroxide, and the abovementioned redox initiators.

In combination with the initiators or with the redox initiator systems, transition metal catalysts can also be used, examples being salts of iron, cobalt, nickel, copper, vanadium and manganese. Examples of suitable salts are iron(I) sulfate, cobalt(II) chloride, nickel(II) sulfate or copper(I) chloride. The concentration used, based on the monomers, of the transition metal salt with reducing action is from 0.1 ppm to 1000 ppm. Combinations of hydrogen peroxide with iron(II) salts can therefore be used, an example being from 0.5 to 30% of hydrogen peroxide and 0.1 to 500 ppm of Mohr's salt.

In combination with the abovementioned initiators it is also possible, in the free-radical copolymerization reaction in organic solvents, to make concomitant use of redox coinitiators and/or of transition metal catalysts, examples being benzoin, dimethylaniline, and ascorbic acid, and heavy-metal complexes soluble in organic solvents, examples being those of copper, cobalt, iron, manganese, nickel and chromium. The amounts usually used of redox coinitiators and, respectively, transition metal catalysts is from about 0.1 to 1000 ppm, based on the amounts used of monomers.

The free-radical copolymerization reaction can also be carried out via exposure to ultraviolet radiation, if appropriate in the presence of UV initiators. Examples of these initiators are compounds such as benzoin and benzoin ethers, α-methylbenzoin or α-phenylbenzoin. The compounds known as triplet sensitizers can also be used, examples being benzyl diketals. Examples of UV radiation sources used are not only high-energy UV lamps such as carbon-arc lamps, mercury vapor lamps or xenon lamps, but also low-UV content light sources, such as fluorescent tubes with high blue content.

In order to control the average molecular weight of the free-radical polymerization reaction in process step (i), it is often advantageous to carry out the free-radical copolymerization reaction in the presence of regulators. Regulators that can be used for this purpose are in particular compounds comprising organic SH groups, in particular water-soluble compounds comprising SH groups, e.g. 2-mercaptoethanol, 2-mercaptopropanol, 3-mercaptopropionic acid, cysteine, N-acetylcysteine, and moreover phosphorus(III) compounds or phosphorus(I) compounds, e.g. alkali metal hypophosphites or alkaline earth metal hypophosphites, an example being sodium hypophosphite, or else hydrogensulfites such as sodium hydrogensulfite. The amounts generally used of the polymerization regulators are from 0.05 to 10% by weight, in particular from 0.1 to 2% by weight, based on the monomers. Preferred regulators are the abovementioned compounds bearing SH groups, in particular water-soluble compounds bearing SH groups, e.g. 2-mercaptoethanol, 2-mercaptopropanol, 3-mercaptopropionic acid, cysteine and N-acetylcysteine. Use of an amount of from 0.05 to 2% by weight, in particular from 0.1 to 1% by weight, of these compounds, based on the monomers, has proven successful. The amounts used of the abovementioned phosphorus(III) compounds and phosphorus(I) compounds, and of the hydrogen sulfites, are usually greater, for example from 0.5 to 10% by weight and in particular from 1 to 8% by weight, based on the monomers to be polymerized. The selection of the appropriate solvent can also be used to influence average molecular weight. By way of example, polymerization in the presence of diluents having benzylic or allylic hydrogen atoms leads via chain transfer to a reduction in average molecular weight.

The free-radical copolymerization reaction in step (i) can take place by the usual polymerization processes, including solution polymerization, precipitation polymerization, suspension polymerization, or bulk polymerization. The solution polymerization method is preferred, i.e. polymerization in solvents or diluents.

Among the suitable solvents or diluents are not only aprotic solvents, e.g. aromatics, such as toluene, o-xylene, p-xylene, cumene, chlorobenzene, ethylbenzene, technical mixtures of alkylaromatics, aliphatics and cycloaliphatics, such as cyclohexane, and technical aliphatic mixtures, ketones such as acetone, cyclohexanone and methyl ethyl ketone, ethers, such as tetrahydrofuran, dioxane, diethyl ether, and tert-butyl methyl ether, and C₁-C₄-alkyl esters of aliphatic C₁-C₄ carboxylic acids, e.g. methyl acetate and ethyl acetate, and also protic solvents, such as glycols and glycol derivatives, polyalkylene glycols and their derivatives, C₁-C₄ alkanols, e.g. n-propanol, n-butanol, isopropanol, ethanol or methanol, but also water and mixtures of water with C₁-C₄ alkanols, an example being isopropanol-water mixtures. The free-radical copolymerization process of the invention preferably takes place in water or in a mixture composed of water with up to 60% by weight of C₁-C₄ alkanols or of glycols, as solvent or diluent. Water is particularly preferably used as sole solvent.

The copolymerization process can moreover be carried out in the presence of surfactants. Surfactants used can be anionic, cationic, nonionic or amphoteric surfactants, or a mixture of these. Either low-molecular-weight surfactants or polymeric surfactants can be used. Examples of nonionic surfactants are adducts of alkylene oxides, in particular ethylene oxide, propylene oxide and/or butylene oxide, on to alcohols, amines, phenols, naphthols or carboxylic acids. Adducts of ethylene oxide and/or propylene oxide onto alcohols comprising at least 10 carbon atoms are advantageously used as surfactants, where the amount of ethylene oxide and/or propylene oxide in the adduct is from 3 to 200 mol per mole of alcohol. The adducts comprise the alkylene oxide units in the form of blocks or in random distribution.

Cationic surfactants are also suitable. Examples of these are the dimethyl-sulfate-quaternized reaction products of 6.5 mol of ethylene oxide with 1 mol of oleylamine, distearyldimethylammonium chloride, laurylmethylammonium chloride or cetylpyridinium bromide, and dimethyl-sulfate-quaternized triethanolamine ester of stearic acid.

The amounts of the surfactants comprised in the copolymerization composition are preferably in the range from 0.01 to 15% by weight, particularly preferably in the range from 0.1 to 5% by weight, based in each case on the weight of the composition.

Other auxiliaries that can be used in process step (i) are stabilizers, thickeners, fillers or cell nucleators or a mixture of these.

The amount preferably used of the auxiliaries in the composition used in the process step (i) is preferably in the range from 0.01 to 15% by weight, particularly preferably in the range from 0.1 to 5% by weight, based in each case on the total weight of the composition.

The free-radical copolymerization process is preferably carried out with substantial or complete exclusion of oxygen, preferably in a stream of inert gas, for example, a stream of nitrogen.

The process of the invention can be carried out in the apparatuses conventionally used in polymerization processes. Among these are stirred tanks, stirred-tank cascades, autoclaves, tubular reactors and kneaders. The free-radical copolymerization reaction is, by way of example, carried out in stirred tanks equipped with an anchor stirrer, blade stirrer, impeller stirrer, or multistage countercurrent pulse agitator. Apparatuses which permit direct isolation of the solid product after the polymerization reaction are particularly suitable, examples being paddle driers. The polymer suspensions obtained can be dried directly in evaporators, for example belt driers, paddle driers, spray driers, or fluidized-bed driers. However, it is also possible to remove most of the inert solvent via filtration or centrifuging and, if appropriate, to use repeated washing with fresh solvent to remove residues—if present—of initiators, monomers and protective colloids, and to delay drying of the copolymers until this has been done.

The free-radical copolymerization reaction usually takes place at temperatures in the range from 0° C. to 300° C., preferably in the range from 40 to 120° C. The polymerization time is usually in the range from 0.5 hours to 15 hours and in particular in the range from 2 to 6 hours. The pressure prevailing during the free-radical copolymerization reaction is relatively unimportant for the success of the polymerization reaction and is generally in the range of 800 mbar to 2 bar and frequently at ambient pressure. If volatile solvents or volatile monomers are used, the pressure can also be higher.

The copolymers obtained in process step (i) are, in process step (ii), reacted with one or more crosslinking agent(s). The reaction takes place, if appropriate, in the presence of a solvent or diluent. Among the suitable solvents or diluents are not only aprotic solvents, e.g. aromatics, such as toluene, o-xylene, p-xylene, cumene, chlorobenzene, ethylbenzene, technical mixtures of alkylaromatics, aliphatics and cycloaliphatics, such as cyclohexane, and technical aliphatic mixtures, ketones such as acetone, cyclohexanone and methyl ethyl ketone, ethers, such as tetrahydrofuran, dioxane, diethyl ether, and tert-butyl methyl ether, and C₁-C₄-alkyl esters of aliphatic C₁-C₄ carboxylic acids, e.g. methyl acetate and ethyl acetate, and also protic solvents, such as glycols and glycol derivatives, polyalkylene glycols and their derivatives, C₁-C₄ alkanols, e.g. n-propanol, n-butanol, isopropanol, ethanol or methanol, but also water and mixtures of water with C₁-C₄ alkanols, an example being isopropanol-water mixtures. The reaction in process step (ii) preferably takes place in water or in a mixture composed of water with up to 60% by weight of C₁-C₄ alkanols or of glycols, as solvent or diluent. Water is particularly preferably used as sole solvent.

The reaction in process step (ii) usually takes place at temperatures in the range from 0° C. to 100° C., preferably in the range from 20 to 80° C. The reaction time is usually in the range from 0.5 hour to 15 hours and in particular in the range from 1 to 2 hours. The pressure prevailing during the reaction is relatively unimportant for the success of the reaction and is generally in the range of 800 mbar to 2 bar and is frequently ambient pressure.

Process step (ii) can, like process step (i), be carried out in the conventional apparatuses described above for polymerization processes. Reference is made here to the information given on free-radical copolymerization.

The thermoplastic molding compositions can comprise from 0 to 60% by weight, in particular up to 40% by weight, preferably up to 30% by weight, of further additives.

The molding compositions of the invention can comprise, as component C), from 0 to 3% by weight, preferably from 0.05 to 3% by weight, with preference from 0.1 to 1.5% by weight, and in particular from 0.1 to 1% by weight, of a lubricant.

Preference is given to salts of A1, of alkali metals, or of alkaline earth metals, or esters or amides of fatty acids having from 10 to 44 carbon atoms, preferably having from 14 to 44 carbon atoms.

The metal ions are preferably alkaline earth metal and A1, particular preference being given to Ca or Mg.

Preferred metal salts are Ca stearate and Ca montanate, and also A1 stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as other components C), heat stabilizers or antioxidants, or a mixture of these, selected from the group of the copper compounds, sterically hindered phenols, sterically hindered aliphatic amines, and/or aromatic amines.

The PA molding compositions of the invention comprise from 0.05 to 3% by weight, preferably from 0.1 to 1.5% by weight, and in particular from 0.1 to 1% by weight, of copper compounds, preferably in the form of Cu(I) halide, in particular in a mixture with an alkali metal halide, preferably KI, in particular in the ratio 1:4, or of a sterically hindered phenol or of an amine stabilizer, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogenous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols are in principle any of the compounds having a phenolic structure and having at least one bulky group on the phenolic ring.

By way of example, compounds of the formula can preferably be used, in which:

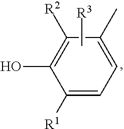

R¹ and R² are an alkyl group, a substituted alkyl group, or a substituted triazole group, where the radicals R¹ and R² can be identical or different, and R³ is an alkyl group, a substituted alkyl group, an alkoxy group, or a substituted amino group.

Antioxidants of the type mentioned are described by way of example in DE-A 27 02 661 (U.S. Pat. No. 4,360,617).

Another group of preferred sterically hindered phenols is that derived from substituted benzenecarboxylic acids, in particular from substituted benzenepropionic acids.

Particularly preferred compounds from this class are compounds of the formula

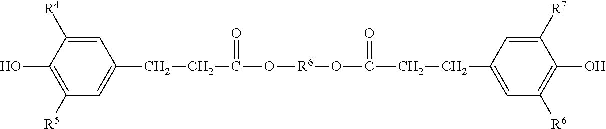

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

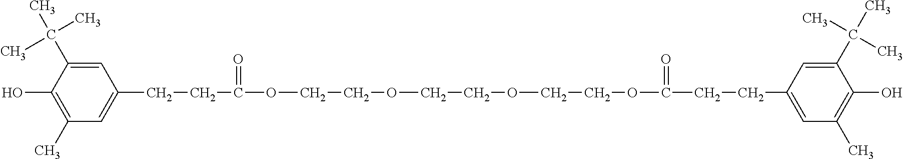

(Irganox® 245 from Ciba-Geigy

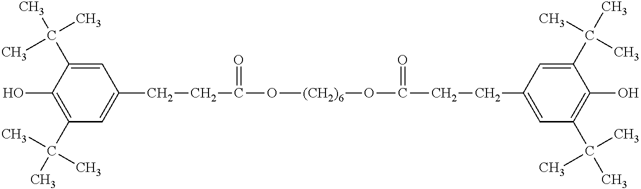

(Irganox® 259 from Ciba Spezialitätenchemie Gmbh)

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxy-phenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydro-cinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxy-benzyl)benzene, 4,4′-methylenebis(2,6-di-tert-butylphenol), 3,5-di-tert-butyl-4-hydroxy-benzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl]propionate (Irganox® 259), pentaerythrityl tetrakis[3-(3,5-di-tert-butyl-4-hydroxyphenyl)propionate], and also N,N′-hexamethylene-bis-3,5-di-tert-butyl-4-hydroxyhydrocinnamide (Irganox® 1098), and the product Irganox® 245 described above from Ciba Spezialitätenchemie GmbH, which has particularly good suitability.

The amount used of the phenolic antioxidants, which are used individually or are in the form of mixtures, is from 0.05 to 3% by weight, preferably from 0.1 to 1.5% by weight, in particular from 0.1 to 1% by weight, based on the total weight of the molding compositions A) to C).

In some instances, sterically hindered phenols which have proven particularly advantageous are those having not more than one sterically hindered group in ortho-position with respect to the phenolic hydroxy group; this is particularly the case when colorfastness is assessed on storage in diffuse light over prolonged periods.

Fibrous or particulate fillers C) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, the amounts used of these being up to 40% by weight, in particular from 1 to 15% by weight.

Preferred fibrous fillers that may be mentioned are carbon fibers, aramid fibers, and potassium titanate fibers, particular preference being given here to glass fibers in the form of E glass. These can be used in the form of rovings or chopped glass in the forms commercially available.

To improve compatibility with the thermoplastic, the fibrous fillers can have been surface-pretreated with a silane compound.

Suitable silane compounds are those of the general formula

(X—(CH₂)ₙ)k—Si—(O—CₘH₂ₘ₋₁)₄₋ₖ

where the substituents are:

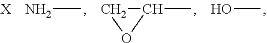

n is a whole number from 2 to 10, preferably from 3 to 4
m is a whole number from 1 to 5, preferably from 1 to 2
k is a whole number from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on the fibrous fillers).

Acicular mineral fillers are also suitable.

For the purposes of the invention, acicular mineral fillers are mineral fillers with very pronounced acicular character. An example which may be mentioned is acicular wollastonite. The L/D (length/diameter) ratio of the mineral is preferably from 8:1 to 35:1, with preference from 8:1 to 11:1. If appropriate, the mineral filler may have been pretreated with the abovementioned silane compounds: however, this pretreatment is not essential.

Further fillers that may be mentioned are kaolin, calcined kaolin, wollastonite, talc, and chalk, and also lamellar or acicular nanofillers, preferably in amounts of from 0.1 to 10%. Preference is given here to use of boehmite, bentonite, montmorillonite, vermiculite, hectorite, and laponite for this purpose. In order to obtain good compatibility of the lamellar nanofillers with the organic binder, organic modification is provided of the lamellar nanofillers according to the prior art. Addition of the lamellar or acicular nanofillers to the nanocomposites of the invention brings about a further increase in mechanical strength.

In particular, talc is used, this being a hydrated magnesium silicate whose constitution is Mg₃[(OH)₂/Si₄O₁₀] or 3 MgO.4 SiO₂.H₂O. These “three-layer phyllosilicates” have a triclinic, monoclinic, or rhombic crystal structure, with lamellar habit. Other trace elements which may be present are Mn, Ti, Cr, Ni, Na, and K, and the OH group may to some extent have been replaced by fluoride.

Examples of impact modifiers as component C) are rubbers, which can have functional groups. It is also possible to use a mixture composed of two or more different impact-modifying rubbers.

Rubbers which increase the toughness of the molding compositions generally comprise elastomeric content whose glass transition temperature is below −10° C., preferably below −30° C., and comprise at least one functional group capable of reaction with the polyamide. Examples of suitable functional groups are carboxylic acid, carboxylic anhydride, carboxylic ester, carboxamide, carboximide, amino, hydroxy, epoxy, urethane, or oxazoline groups, preferably carboxylic anhydride groups.

Among the preferred functionalized rubbers are functionalized polyolefin rubbers whose structure is composed of the following components:
1. from 40 to 99% by weight of at least one alpha-olefin having from 2 to 8 carbon atoms,
2. from 0 to 50% by weight of a diene,
3. from 0 to 45% by weight of a C₁-C₁₂-alkyl ester of acrylic acid or methacrylic acid, or a mixture of such esters,
4. from 0 to 40% by weight of an ethylenically unsaturated C₂-C₂₀ mono- or dicarboxylic acid or of a functional derivative of such an acid,
5. from 0 to 40% by weight of a monomer comprising epoxy groups, and
6. from 0 to 5% by weight of other monomers capable of free-radical polymerization where the entirety of components 3) to 5) is at least from 1 to 45% by weight, based on components 1) to 6).

Examples that may be mentioned of suitable α-olefins are ethylene, propylene, 1-butylene, 1-pentylene, 1-hexylene, 1-heptylene, 1-octylene, 2-methylpropylene, 3-methyl-1-butylene, and 3-ethyl-1-butylene, preferably ethylene and propylene.

Examples that may be mentioned of suitable diene monomers are conjugated dienes having from 4 to 8 carbon atoms, such as isoprene and butadiene, non-conjugated dienes having from 5 to 25 carbon atoms, such as penta-1,4-diene, hexa-1,4-diene, hexa-1,5-diene, 2,5-dimethylhexa-1,5-diene, and octa-1,4-diene, cyclic dienes, such as cyclopentadiene, cyclohexadienes, cyclooctadienes, and dicyclopentadiene, and also alkenylnorbornene, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0^{2.6}]-3,8-decadiene, or a mixture of these. Preference is given to hexa-1,5-diene, 5-ethylidenenorbornene, and dicyclopentadiene.

The diene content is preferably from 0.5 to 50% by weight, in particular from 2 to 20% by weight, and particularly preferably from 3 to 15% by weight, based on the total weight of the olefin polymer. Examples of suitable esters are methyl, ethyl, propyl, n-butyl, isobutyl, and 2-ethylhexyl, octyl, and decyl acrylates and the corresponding methacrylates. Among these, particular preference is given to methyl, ethyl, propyl, n-butyl, and 2-ethylhexyl acrylate and the corresponding methacrylate.

Instead of the esters, or in addition to these, acid-functional and/or latent acid-functional monomers of ethylenically unsaturated mono- or dicarboxylic acids can also be present in the olefin polymers.

Examples of ethylenically unsaturated mono- or dicarboxylic acids are acrylic acid, methacrylic acid, tertiary alkyl esters of these acids, in particular tert-butyl acrylate, and dicarboxylic acids, e.g. maleic acid and fumaric acid, or derivatives of these acids, or else their monoesters.

Latent acid-functional monomers are compounds which, under the polymerization conditions or during incorporation of the olefin polymers into the molding compositions, form free acid groups. Examples that may be mentioned of these are anhydrides of dicarboxylic acids having from 2 to 20 carbon atoms, in particular maleic anhydride and tertiary C₁-C₁₂-alkyl esters of the abovementioned acids, in particular tert-butyl acrylate and tert-butyl methacrylate.

Examples of other monomers that can be used are vinyl esters and vinyl ethers.

Particular preference is given to olefin polymers composed of from 50 to 98.9% by weight, in particular from 60 to 94.85% by weight, of ethylene and from 1 to 50% by weight, in particular from 5 to 40% by weight, of an ester of acrylic or methacrylic acid, from 0.1 to 20.0% by weight, and in particular from 0.15 to 15% by weight, of glycidyl acrylate and/or glycidyl methacrylate, acrylic acid, and/or maleic anhydride.

Particularly suitable functionalized rubbers are ethylene-methyl methacrylate-glycidyl methacrylate polymers, ethylene-methyl acrylate-glycidyl methacrylate polymers, ethylene-methyl acrylate-glycidyl acrylate polymers, and ethylene-methyl methacrylate-glycidyl acrylate polymers.

The polymers described above can be prepared by processes known per se, preferably via random copolymerization at high pressure and elevated temperature.

The melt index of these copolymers is generally in the range from 1 to 80 g/10 min (measured at 190° C. with a load of 2.16 kg).

Other rubbers that may be used are commercial ethylene-α-olefin copolymers which comprise groups reactive with polyamide. The underlying ethylene-α-olefin copolymers are prepared via transition-metal catalysis in the gas phase or in solution. The following α-olefins can be used as comonomers: propylene, 1-butene, 1-pentene, 4-methyl-1-pentene, 1-hexene, 1-heptene, 1-octene, 1-nonene, 1-decene, 1-undecene, 1-dodecene, styrene and substituted styrenes, vinyl esters, vinyl acetates, acrylic esters, methacrylic esters, glycidyl acrylates, glycidyl methacrylates, hydroxyethyl acrylates, acrylamides, acrylonitrile, allylamine; dienes, e.g. butadiene, isoprene.

Ethylene/1-octene copolymers, ethylene/1-butene copolymers, ethylene-propylene copolymers are particularly preferred, and compositions composed of
25 to 85% by weight, preferably 35 to 80% by weight of ethylene,
14.9 to 72% by weight, preferably 19.8 to 63% by weight of 1-octene or 1-butene or propylene, or a mixture of these
0.1 to 3% by weight, preferably 0.2 to 2% by weight of an ethylenically unsaturated mono- or dicarboxylic acid, or of a functional derivative of such an acid
   are particularly preferred.

The molar mass of these ethylene-α-olefin copolymers is from 10 000 to 500 000 g/mol, preferably from 15 000 to 400 000 g/mol (Mn, determined by means of GPC in 1,2,4-trichlorobenzene using PS calibration).

The proportion of ethylene in the ethylene-α-olefin copolymers is from 5 to 97% by weight, preferably from 10 to 95% by weight, in particular from 15 to 93% by weight.

One particular embodiment prepared ethylene-α-olefin copolymers by using what are known as “single site catalysts”. Further details can be found in U.S. Pat. No. 5,272,236. In this case, the polydispersity of the ethylene-α-olefin copolymers is narrow for polyolefins: smaller than 4, preferably smaller than 3.5.

Another group of suitable rubbers that may be mentioned is provided by core-shell graft rubbers. These are graft rubbers which are prepared in emulsion and which are composed of at least one hard constituent and of at least one soft constituent. A hard constituent is usually a polymer whose glass transition temperature is at least 25° C., and a soft constituent is usually a polymer whose glass transition temperature is at most 0° C. These products have a structure composed of a core and of at least one shell, and the structure here results via the sequence of addition of the monomers. The soft constituents generally derive from butadiene, isoprene, alkyl acrylates, alkyl methacrylates, or siloxanes, and, if appropriate, from further comonomers. Suitable siloxane cores can, for example, be prepared starting from cyclic oligomeric octamethyltetrasiloxane or tetravinyltetramethyltetrasiloxane. By way of example, these can be reacted with γ-mercaptopropylmethyldimethoxysilane in a ring-opening cationic polymerization reaction, preferably in the presence of sulfonic acids, to give the soft siloxane cores. The siloxanes can also be crosslinked, for example by carrying out the polymerization reaction in the presence of silanes having hydrolyzable groups, such as halogen or alkoxy groups, e.g. tetraethoxysilane, methyltrimethoxysilane, or phenyltrimethoxysilane. Suitable comonomers that may be mentioned here are, for example, styrene, acrylonitrile, and crosslinking or graft-active monomers having more than one polymerizable double bond, e.g. diallyl phthalate, divinylbenzene, butanediol diacrylate, or triallyl(iso)cyanurate. The hard constituents generally derive from styrene, and from alpha-methylstyrene, and from their copolymers, and preferred comonomers that may be listed here are acrylonitrile, methacrylonitrile, and methyl methacrylate.

Preferred core-shell graft rubbers comprise a soft core and a hard shell, or a hard core, a first soft shell, and at least one further hard shell. Functional groups, such as carbonyl, carboxylic acid, anhydride, amide, imide, carboxylic ester, amino, hydroxy, epoxy, oxazoline, urethane, urea, lactam, or halobenzyl groups, are preferably incorporated here via addition of suitably functionalized monomers during polymerization of the final shell. Examples of suitable functionalized monomers are maleic acid, maleic anhydride, mono- or diesters or maleic acid, tert-butyl (meth)acrylate, acrylic acid, glycidyl(meth)acrylate, and vinyloxazoline. The proportion of monomers having functional groups is generally from 0.1 to 25% by weight, preferably from 0.25 to 15% by weight, based on the total weight of the core-shell graft rubber. The ratio by weight of soft to hard constituents is generally from 1:9 to 9:1, preferably from 3:7 to 8:2.

Such rubbers are known per se and are described by way of example in EP-A-0 208 187. Oxazine groups for functionalization can be incorporated by way of example according to EP-A-0 791 606.

Another group of suitable impact modifiers is provided by thermoplastic polyester elastomers. Polyester elastomers here are segmented copolyetheresters which comprise long-chain segments which generally derive from poly(alkylene)ether glycols and comprise short-chain segments which derive from low-molecular-weight diols and from dicarboxylic acids. Such products are known per se and are described in the literature, e.g. in U.S. Pat. No. 3,651,014. Appropriate products are also commercially available as Hytrel™ (Du Pont), Arnitel™ (Akzo), and Pelprene™ (Toyobo Co. Ltd.).

It is, of course, also possible to use a mixture of various rubbers.

The thermoplastic molding compositions of the invention can comprise, as further component C), conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and further amines (e.g. TAD), hydroquinones, various substituted representatives of these groups, and their mixtures, at concentrations of up to 1% by weight, based on the weight of the thermoplastic molding composition.

UV stabilizers that may be mentioned, the amounts of which generally used are up to 2% by weight, based on the molding composition, are various substituted resorcinols, salicylates, benzotriazoles, and benzophenones.

Colorants that may be added are inorganic pigments, such as titanium dioxide, ultramarine blue, iron oxide, and carbon black and/or graphite, and also organic pigments, such as phthalocyanines, quinacridones, perylenes, and also dyes, such as nigrosin and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame retardant systems and their synergists.

The thermoplastic molding compositions of the invention can be prepared by processes known per se, by mixing the starting components in conventional mixing apparatuses, such as screw extruders, Brabender mixers, or Banbury mixers, and then extruding them. The extrudate can be cooled and comminuted. It is also possible to premix individual components and then to add the remaining starting materials, individually and/or likewise mixed. The mixing temperatures are generally from 150 to 320° C., preferably from 200 to 250° C. The residence time is usually from 1 to 10 min., preferably from 2 to 5 min.

After mixing of components A) and B), and also, if appropriate, C), the polyamide molding compositions of the invention comprise up to 50 meq/kg of A), preferably up to 40 meq/kg of A), of crosslinked units, in particular crosslinked by way of an imide function. This can be discerned by taking the difference in the conventional titration of the free NH₂ end groups prior to and after homogenization of the mixture.

The thermoplastic molding compositions of the invention feature better storage stability and controlled foam production.

These materials are suitable for the production of moldings of any type.

These moldings can be ready-to-use moldings. The foam is advantageously produced from pellets. The polymer foam is generally produced in a further process step. This can advantageously take place thermally or via exposure to microwaves.

During the foaming process, the potential blowing agent bound within the polymer decomposes primarily via decarboxylation of the free carboxy groups of the itaconic acid, mesaconic acid, fumaric acid, maleic acid, aconitic acid, or glutaronic acid. The decarboxylation liberates a sufficient amount of CO₂ to foam the molding Compositions of the invention. The polyamides of the invention therefore provide their own blowing agent and in this sense are to a certain extent “self-foaming”.

The temperatures during the thermal production process are generally from 140 to 280° C. preferably from 160 to 250° C. The residence time is from 1 to 80 min., preferably from 5 to 70 min.

The resultant foams or, respectively, foam-like polymer structures feature a density in the range from 100 to 1200 g/l, preferably in the range from 200 to 1100 g/l, and very particularly preferably from 200 to 800 g/l.

The foams of the invention have good expansion (from 100 to 150%), good adhesion to other surfaces (in particular metal surfaces), and good resistance to liquids.

The foamable molding compositions described are suitable for the production of reinforcing elements for hollow profiles (metallic structures), e.g. motor vehicle construction (bodywork). Glassfiber-reinforced molding compositions are particularly used for this purpose. The reinforcing elements produced by way of example by injection molding of these molding compositions are inserted or installed into a cavity of the metallic structure. The foaming process that occurs during heat treatment, e.g. on passage through the drying steps in the course of painting of the untreated vehicle bodywork, foams the reinforcing component, so that it completely fills the available cavity. Corresponding reinforcing elements composed of a non-foamable glassfiber-reinforced polyamide and of a foamable second component injected on to the material (for example a foamable epoxide) are described inter alia in J. Kempf, M. Derks VDI Congress “Plastics in automotive engineering”, Mannheim 2006 or EP application no. 08151418.4.

The polyamide molding compositions described above can be used instead of the epoxy foam and preferably comprise glassfiber-reinforced polyamide (up to 40% by weight of glassfibers) as core material of the reinforcing component. The reinforcing component can be produced via coextrusion (e.g. injection around the material) or sequential extrusion (multicomponent injection molding), or can be applied to sheetmetal carriers. These reinforcing components are generally introduced into the hollow (metal) profiles. The reinforcing components can (with appropriate undersize) easily be inserted into the hollow profile and foamed. This makes it possible to compensate tolerances, and there is sufficient space for runoff of excess CE coating.

The foaming process usually takes place during the coating of the automobile by CE (cathodic electrodeposition), with subsequent curing in the CE oven.

An advantage of the reinforcing component of the invention here is that the adhesion between core and foam is better, and there is therefore no need to use any additional adhesive. There is moreover better adhesion to the metal.

Another novel application of the material described is the use as what is known as “single-substance system” for reinforcing elements for hollow profiles (see above). Whereas previous reinforcing elements are composed of two functional units that are separate from one another (thermoplastic support internally to absorb load or for acoustic decoupling plus foaming bonding composition externally), the molding compositions of the invention can also produce this type of reinforcing element in one piece/from a single substance, i.e. exclusively from the molding compositions of the invention. Given appropriate formulation and processing, the molding compositions of the invention transmit mechanical loads and provide acoustic decoupling, while simultaneously assuming the function of binding to the surrounding hollow metal profile. When the molding compositions of the invention are used, there is no need for the additional adhesive used in the previous reinforcing elements.

A further use of the molding compositions of the invention is processing for extrusion of the connecting profiles and reinforcing profiles used in window construction to produce an interlocking and thermally insulating connection between the inner and outer side of aluminum window frames. Profiles composed of glassfiber-reinforced, non-foamable polyamides are usually used for this purpose, if appropriate also comprising rubber or other elastomers as impact modifiers. Use of profiles composed of the molding compositions of the invention, and the foaming of the profiles in the course of extrusion or after assembly, can give a further improvement in the thermal insulation effect of the profiles.

### EXAMPLES

### Components A

A1: PA6I, Tg=125° C., IV=104 ml/g (PA6I=isophthalic acid/hexamethylenediamine)
A2: PA12/L1 (copolymer: laurolactam/isophthalic acid/bis(4-aminocyclohexyl)-methane) Tg=110° C. IV=75 ml/g
A3: PA66/D6/6 (copolymer: caprolactam, AH salt, bis(4-aminocyclohexyl)-2,2-propane, adipic acid), Tg=73° C., IV=120 ml/g
A4: PA6, Tg=60° C., Tm=220° C., IV=150 ml/g
A5: PA5-10, Tg=51° C., Tm=215° C., IV=107 ml/g
A6: PA-bMACM-14, Tg=145° C., IV=62 ml/g
A7: PA-L12-bMACM-I-T (copolymer of laurolactam, bis(3-methyl-4-aminocyclohexyl)methane, isophthalic acid, and terephthalic acid) Tg=123° C., IV=75 ml/g

### Components B

B1: methyl methacrylate/itaconic acid copolymer (constitution: 70/30 wt %, Mw=33 000, Mn=12 000, K value=25)
B2: methyl methacrylate/itaconic acid copolymer (constitution: 80/20 wt %, Mw=33 700, Mn=12 600, K value=25.9) T_{G}=10° C.
B3: methyl methacrylate/itaconic acid copolymer (constitution: 50/50 wt % MMA/IA, Mw=23 800, Mn=5200, K value=19.5)
B4: methyl methacrylate/itaconic acid copolymer (constitution: 89/11 wt % MMA/IA, Mw=35 300, Mn=13 000, K value=24.9)
B5: n-butyl acrylate/itaconic acid copolymer (constitution: 50/50 wt % n-butyl acrylate/IA Mw=10 000, Mn=5300, K value=20.3)

### Preparation Specification:

N₂ was introduced into a 1 l flask comprising itaconic acid and 400 g of 1,4-dioxane, and the mixture was heated to 95° C. MMA or n-butyl acrylate (corresponding to the abovementioned ratio) and a solution composed of 8 g of tert-butyl pivalate in 1,4-dioxane were added. The mixture was then stirred for 2 hours, and more tert-butyl pivalate was added, and the mixture was polymerized for 2 hours. The solvent was drawn off, and the polymer was dried in vacuo at 60° C.

### Components C

C1: Plasticizer: N-2-hydroxypropylbenzenesulfonamide
C2: Plasticizer: triethylene glycol
C3: HP 325 talc
C4: Glass fibers

### IV Measurements:

PA: in capillary viscometer, 5 g/l solution in 96% sulfuric acid, T=25° C. (ISO 307)
IA copolymer: in capillary viscometer, 10 g/l solution in THF, T=25° C.
T_{G} measurements: heating/cooling rate 20 K/min., by means of DSC, 2nd heating curve

The blends were prepared in an extruder (DSM Micro 15), and Charpy specimens were injection-molded (DSM micro-injection-molding machine, 10 cc). The foam was produced after storage of the specimens in a drying oven. The constitution of the blends and the extrusion conditions, injection-molding conditions, and foaming conditions are collated in tables 1 and 2.

TABLE 1

| | | | | | | | | Production conditions | | | | | | | |
|---|---|---|---|---|---|---|---|---|---|---|---|---|---|---|---|
| | | | | | | | | Miniextruder | | | | | | | |
| | | | | | | | | | Residence | Rotation | Injection molding | | Foaming | | |
| Component A | | Component B | | Component C | | | | T | time | time | Mold T | Melt T | T | Time | Density |
| | [wt %] | | [wt %] | | [wt %] | | | [° C.] | [min] | [rpm] | [° C.] | [° C.] | [° C.] | [min] | [g/l] |
| A1 | 70 | B1 | 30 | — | — | — | — | 230 | 3 | 80 | 80 | 230 | 180 | 30 | 515-520 |
| A1 | 70 | B2 | 30 | — | — | — | — | 230 | 3 | 80 | 80 | 230 | 180 | 30 | 666 |
| A1 | 70 | B2 | 30 | — | — | — | — | 230 | 3 | 80 | 80 | 230 | 180 | 12 | 768 |
| A1 | 70 | B2 | 30 | — | — | — | — | 230 | 3 | 80 | 80 | 230 | 160 | 45 | 720 |
| A1 | 70 | B2 | 30 | — | — | — | — | 230 | 3 | 80 | 80 | 230 | 200 | 13 | 661 |
| A1 | 70 | B2 | 30 | — | — | — | — | 230 | 3 | 80 | 80 | 230 | 220 | 9 | 581 |
| A1 | 62.3 | B2 | 30 | C1 | 7 | C3 | 0.69 | 230 | 3 | 80 | 80 | 230 | 180 | 20 | 853 |
| A1 | 62.3 | B2 | 30 | C1 | 7 | C3 | 0.69 | 210 | 3 | 80 | 80 | 210 | 180 | 20 | 791 |
| A1 | 62.3 | B2 | 30 | C2 | 7 | C3 | 0.69 | 230 | 3 | 80 | 80 | 230 | 180 | 20 | 609 |
| A1 | 62.3 | B2 | 30 | C2 | 7 | C3 | 0.69 | 210 | 3 | 80 | 80 | 210 | 180 | 20 | 1132 |
| A2 | 70 | B2 | 30 | — | — | — | — | 230 | 3 | 80 | 80 | 230 | 160 | 70 | 725 |
| A2 | 70 | B2 | 30 | — | — | — | — | 230 | 3 | 80 | 80 | 230 | 180 | 10 | 618 |
| A2 | 70 | B2 | 30 | — | — | — | — | 230 | 3 | 80 | 80 | 230 | 190 | 15 | 668 |
| A2 | 70 | B2 | 30 | — | — | — | — | 210 | 3 | 80 | 80 | 210 | 190 | 15 | 630 |
| A3 | 70 | B2 | 30 | — | — | — | — | 230 | 3 | 80 | 80 | 230 | 180 | 30 | 831 |
| A3 | 70 | B2 | 30 | — | — | — | — | 210 | 3 | 80 | 80 | 210 | 180 | 30 | 943 |
| A3 | 70 | B2 | 30 | — | — | — | — | 210 | 3 | 80 | 80 | 210 | 200 | 10 | 792 |
| A3 | 69 | B2 | 30 | C3 | 1 | — | — | 190 | 3 | 80 | 80 | 190 | 180 | 30 | 882 |
| A3 | 69 | B2 | 30 | C3 | 1 | — | — | 190 | 3 | 80 | 80 | 190 | 200 | 10 | 709 |

TABLE 2

| | | | | | | Production conditions | | | | | | | |
|---|---|---|---|---|---|---|---|---|---|---|---|---|---|
| | | | | | | Miniextruder | | | | | | | |
| | | | | | | | Residence | Rotation | Injection molding | | Foaming | | |
| Component A | | Component B | | Component C | | T | time | time | Mold T | Melt T | T | Time | Density |
| | [wt %] | | [wt %] | | [wt %] | [° C.] | [min] | [rpm] | [° C.] | [° C.] | [° C.] | [min] | [g/l] |
| A4 | 70 | B1 | 30 | — | — | 235 | 230 | 80 | 80 | 235 | 240 | 20 | 413 |
| A4 | 70 | B2 | 30 | — | — | 235 | 230 | 80 | 80 | 235 | 240 | 20 | 483 |
| A5 | 70 | B1 | 30 | — | — | 230 | 230 | 80 | 80 | 230 | 240 | 10 | 502 |
| A5 | 70 | B2 | 30 | — | — | 230 | 230 | 80 | 80 | 230 | 240 | 10 | 479 |
| A1 | 63 | B1 | 27 | C4 | 10 | 260 | 230 | 80 | 80 | 260 | 180 | 10 | 573 |
| A1 | 76.5 | B1 | 13.5 | C4 | 10 | 260 | 230 | 80 | 80 | 260 | 180 | 10 | 1031 |
| A1 | 76.5 | B1 | 13.5 | C4 | 10 | 260 | 230 | 80 | 80 | 260 | 180 | 40 | 966 |
| A1 | 85 | B1 | 15 | — | — | 230 | 230 | 80 | 80 | 230 | 180 | 10 | 489 |
| A1 | 85 | B2 | 15 | — | — | 230 | 230 | 80 | 80 | 230 | 180 | 10 | 413 |
| A1 | 85 | B3 | 15 | — | — | 230 | 230 | 80 | 80 | 230 | 180 | 10 | 392 |
| A1 | 85 | B4 | 15 | — | — | 230 | 230 | 80 | 80 | 230 | 180 | 20 | 520 |
| A6 | 85 | B1 | 15 | — | — | 230 | 230 | 80 | 80 | 230 | 180 | 20 | 493 |
| A7 | 85 | B1 | 15 | — | — | 230 | 230 | 80 | 80 | 230 | 180 | 10 | 577 |
| A1 | 70 | B3 | 30 | — | — | 230 | 230 | 80 | 80 | 230 | 180 | 10 | 421 |
| A1 | 70 | B4 | 30 | — | — | 230 | 230 | 80 | 80 | 230 | 180 | 10 | 706 |
| A1 | 70 | B4 | 30 | — | — | 230 | 230 | 80 | 80 | 230 | 180 | 30 | 608 |
| A1 | 60 | B1 | 40 | — | — | 230 | 230 | 80 | 80 | 230 | 180 | 10 | 467 |
| A1 | 60 | B2 | 40 | — | — | 230 | 230 | 80 | 80 | 230 | 180 | 10 | 770 |
| A1 | 60 | B2 | 40 | — | — | 230 | 230 | 80 | 80 | 230 | 180 | 40 | 503 |

| | | | | | | Production conditions | | | | | | | |
|---|---|---|---|---|---|---|---|---|---|---|---|---|---|
| | | | | | | Miniextruder | | | | | | | |
| Component | | Component | | Component | | | Residence | Rotation | Injection molding | | Foaming | | |
| A | | B | | C | | T | time | time | FormT | SchmeizeT | T | Time | Density |
| | [wt %] | | [wt %] | | [wt %] | [° C.] | [min] | [rpm] | [° C.] | [° C.] | [° C.] | [min] | [g/l] |
| A1 | 60 | B3 | 40 | — | — | 230 | 230 | 80 | 80 | 230 | 180 | 10 | 605 |
| A1 | 60 | B3 | 40 | — | — | 230 | 230 | 80 | 80 | 230 | 180 | 40 | 410 |
| A1 | 60 | B4 | 40 | — | — | 230 | 230 | 80 | 80 | 230 | 180 | 10 | 885 |
| A1 | 60 | B4 | 40 | — | — | 230 | 230 | 80 | 80 | 230 | 180 | 40 | 581 |
| A1 | 70 | B5 | 30 | — | — | 230 | 230 | 80 | 80 | 230 | 180 | 10 | 333 |
| A1 | 70 | B5 | 30 | — | — | 230 | 230 | 80 | 80 | 230 | 180 | 20 | 310 |
| A1 | 70 | B5 | 30 | — | — | 230 | 230 | 80 | 80 | 230 | 180 | 30 | 290 |
| A1 | 70 | B5 | 30 | — | — | 230 | 230 | 80 | 80 | 230 | 180 | 40 | 271 |
| A1 | 85 | B5 | 15 | — | — | 230 | 230 | 80 | 80 | 230 | 180 | 10 | 286 |
| A1 | 85 | B5 | 15 | — | — | 230 | 230 | 80 | 80 | 230 | 180 | 20 | 284 |
| A1 | 85 | B5 | 15 | — | — | 230 | 230 | 80 | 80 | 230 | 180 | 30 | 263 |
| A1 | 85 | B5 | 15 | — | — | 230 | 230 | 80 | 80 | 230 | 180 | 40 | 239 |

1-13. (canceled)

14. A process for the production of polymer foams, which comprises blending thermoplastic molding compositions comprising
A) from 10 to 99.9% by weight of at least one thermoplastic polyamide
B) from 0.1 to 50% by weight of a copolymer obtainable via
(i) preparation of at least one reaction mixture (a) via free-radical copolymerization of one or more monoethylenically unsaturated monomeric compound(s) (monomer(s) B1) with one or more compound(s) selected from the group of itaconic acid, mesaconic acid, fumaric acid, maleic acid, aconitic acid, glutaconic acid, and salts, esters, and anhydrides thereof (monomer(s) B2), and
(ii) optionally, reaction of at least one of the copolymers obtained in step (i) with one or more crosslinking agent(s) (b), and
C) from 0 to 60% by weight of further additives,
where the total of the percentages by weight of components A) to C) is 100%, in the extruder and, in a further process step, producing a polymer foam thermally at temperatures of from 140 to 260° C. or via exposure to microwaves.

15. The process according to claim 14, in which component A) is composed of a mixture of amorphous with semicrystalline polyamides.

16. The process according to claim 14, where the monoethylenically unsaturated compound(s) (monomer(s) B1) has/have been selected from the group consisting of vinyl chloride, vinylidene chloride, vinyl acetate, methyl(meta)acrylate, vinyl propionate, vinyl n-butyrate, vinyl laurate, vinyl stearate, acrylonitrile, methacrylonitrile, fumaronitrile, maleonitrile, acrylamide, methacrylamide, vinylsulfonic acid, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, 2′-methylisocrotonic acid, cinnamic acid, p-chlorocinnamic acid, citraconic acid, tricarboxyethylene anhydride, alkyl acrylates, or styrene or substituted styrenes of the general formula 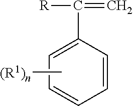
where R is an alkyl radical having from 1 to 8 carbon atoms, a hydrogen atom, or a halogen atom, and R¹ is an alkyl radical having from 1 to 8 carbon atoms or a halogen atom, and n has the value 0, 1, 2, or 3,
or a mixture of these.

17. The process according to claim 14, where, in process step (i), the amount used of the monomers B1 is from 50 to 99% by weight, and the amount used of the monomers B2 is from 1 to 50% by weight.

18. The process according to claim 14, where the ratio by weight of reaction mixture (a) to crosslinking agent (h) is from 1:10 to 100:1.

19. The process according to claim 14, in which the average (weight-average) molar mass of the copolymer B) from step (i) is from 3000 to 1 000 000 g/mol.

20. A polymer foam, obtainable under the process conditions of claim 14.

21. A reinforcing element for hollow profiles in motor vehicle bodywork, obtainable according to claim 14.

22. A connecting or reinforcing profile for window elements, obtainable under the process conditions according to claim 14.

23. The process according to claim 15, where the monoethylenically unsaturated compound(s) (monomer(s) B1) has/have been selected from the group consisting of vinyl chloride, vinylidene chloride, vinyl acetate, methyl(meta)acrylate, vinyl propionate, vinyl n-butyrate, vinyl laurate, vinyl stearate, acrylonitrile, methacrylonitrile, fumaronitrile, maleonitrile, acrylamide, methacrylamide, vinylsulfonic acid, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, 2′-methylisocrotonic acid, cinnamic acid, p-chlorocinnamic acid, citraconic acid, tricarboxyethylene anhydride, alkyl acrylates, or styrene or substituted styrenes of the general formula 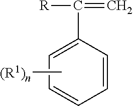
where R is an alkyl radical having from 1 to 8 carbon atoms, a hydrogen atom, or a halogen atom, and R¹ is an alkyl radical having from 1 to 8 carbon atoms or a halogen atom, and n has the value 0, 1, 2, or 3,
or a mixture of these.

24. The process according to claim 15, where, in process step (i), the amount used of the monomers B1 is from 50 to 99% by weight, and the amount used of the monomers B2 is from 1 to 50% by weight.

25. The process according to claim 16, where, in process step (i), the amount used of the monomers B1 is from 50 to 99% by weight, and the amount used of the monomers 132 is from 1 to 50% by weight.

26. The process according to claim 15, where the ratio by weight of reaction mixture (a) to crosslinking agent (h) is from 1:10 to 100:1.

27. The process according to claim 16, where the ratio by weight of reaction mixture (a) to crosslinking agent (b) is from 1:10 to 100:1.

28. The process according to claim 17, where the ratio by weight of reaction mixture (a) to crosslinking agent (b) is from 1:10 to 100:1.

29. The process according to claim 15, in which the average (weight-average) molar mass of the copolymer B) from step (i) is from 3000 to 1 000 000 g/mol.

30. The process according to claim 16, in which the average (weight-average) molar mass of the copolymer B) from step (i) is from 3000 to 1 000 000 g/mol.

31. The process according to claim 17, in which the average (weight-average) molar mass of the copolymer B) from step (i) is from 3000 to 1 000 000 g/mol.

32. The process according to claim 18, in which the average (weight-average) molar mass of the copolymer B) from step (i) is from 3000 to 1 000 000 g/mol.

33. A polymer foam, obtainable under the process conditions of claim 15.
